(19) United States
(12) Patent Application Publication
(10) Pub. No.: US 2008/0044565 A1
(43) Pub. Date: Feb. 21, 2008

(54) PROCESS FOR APPLYING A POLYVINYL ESTER DISPERSION-BASED ADHESIVE BY MEANS OF NOZZLE APPLICATION AND USE OF POLYVINYL ESTER DISPERSION-BASED ADHESIVES

(75) Inventors: Harmin Mueller, Hofheim (DE); Hans Uwe Faust, Liederbach (DE); Martin Schaefer, Landau I. D. Pfalz (DE)

Correspondence Address: CONNOLLY BOVE LODGE & HUTZ, LLP, P O BOX 2207, WILMINGTON, DE, 19899, US

(73) Assignee: Celanese Emulsions GmbH, Kronberg/Ts. (DE)

(21) Appl. No.: 11/835,128

(22) Filed: Aug. 7, 2007

(30) Foreign Application Priority Data
Aug. 8, 2006 (DE) 10 2006 037 318.9

(51) Int. Cl. B05D 5/10; C08G 18/62

(52) U.S. Cl. 427/207.1; 524/832

(57) ABSTRACT

Process for applying a polyvinyl ester dispersion-based adhesive by means of nozzle application and use of polyvinyl ester dispersion-based adhesives A description is given of an application process for polyvinyl ester dispersion-based adhesives through nozzles to a substrate, wherein an aqueous, primarily emulsifier-stabilized vinyl ester polymer dispersion having a solids content of at least 40% by weight, a viscosity of less than 8000 mPas, and a vinyl ester polymer glass transition temperature of −30 to +40° C. is supplied to the nozzle and is applied from the nozzle, in the form of a thin jet or of a predeterminedly interrupted thin jet, to the substrate. The process can be implemented for long periods without interruption, and the adhesive bonding takes place at high speed.

Process for applying a polyvinyl ester dispersion-based adhesive by means of nozzle application and use of polyvinyl ester dispersion-based adhesives

The present invention relates to an application process for selected dispersion-based adhesives through high-speed nozzles and to the use of selected dispersion-based adhesives for nozzle application.

Dispersion-based adhesives for bonding paper in the production-line fabrication of folding boxes, envelopes, brochures or cigarettes are often applied to the substrate by means of a rotating segmented wheel, by means of a roller or by means of a nozzle application system.

With these modes of application, particularly in the case of the rotating segmented wheel and the roller, adhesive contamination caused by “splashing” or imprecise application of adhesive leads to problems in the fabrication process. If adhesive gets onto the conveyor belt, it can lead to instances of sticking of the fabricated material, leading in turn to machine downtime in conjunction with laborious cleaning work.

In the case of application by means of a segmented wheel or a roller, contamination is caused primarily as a result of the centrifugal forces of the rotating wheel, acting on the adhesive, in the form of “splashes”. Within the art, attempts are made to avoid this by optimizing the physicochemical properties of the adhesive such that strong internal cohesion forces within the adhesive counteract the centrifugal forces.

The use of nozzles is particularly advantageous, since first it is easily possible to adapt the geometry of the product to be bonded, and second it is possible to save on adhesive.

When an adhesive is applied by means of a nozzle application system, contamination comes about by virtue of the fact that, over the course of time, stalactites of dried adhesive form at the exit site of the nozzle and divert the jet of adhesive exiting the nozzle. The consequence is a high degree of variation in the precision of application. Variation in the precision of glue application leads consequently to contamination of the plant, or even to its shutdown.

When an adhesive is applied by means of a nozzle application system, the adhesive is conveyed by means of a pump through a closed line system. Located at the end of the line system is a nozzle with a valve which opens and closes rapidly. Since the paper parts to be bonded are transported on a conveyor belt having a very high running speed, presently about 100 to 800 m/min, the valve is required to possess a short cycle time. If, for example, with a belt speed of 100 m/min, you wanted to apply dots at one dot/cm, then 166 dots are applied every second. The opening time of the valve in this case is therefore in the region <6 msec. At a belt speed of 250 m/s, 415 dots are applied every second, corresponding to an opening time of <2.5 ms.

Nozzle application systems having switching frequencies of up to 1000/second are nowadays state of the art. As a result of the high cycle frequency of the nozzle valves
the adhesive inside the nozzle is exposed to extremely high shearing forces, and
per unit time, within one hour, for example, over 1,000,000 individual drops are applied through one nozzle.

Owing to the high level of shearing of material and to the short time given for an individual drop to form by opening and closing of the valve, the formation of drops may be accompanied, at the exit of the nozzle, by formation of smaller individual drops, referred to as “satellite drops”, whose high number at the exit of the nozzle gives rise over time to a stalactitic buildup of contamination (known as “dirt formation”).

The question of how “clean” a drop is formed in the course of this extrusion process ought to be dependent on the physicochemical properties of the dispersion, such as, for example, its rheology, surface tension, shearing stability, yield point, and elasticity.

Described in the prior art are a number of processes for the application of adhesives from nozzles.

For instance EP-A-523,589 describes a process for applying adhesive dots contactlessly by means of nozzles. This specification describes a selective application process and also a suitable apparatus for it. Application takes place from high-speed nozzles. The characteristic features of the process are that a belt with cutouts is guided parallel to the line on which the nozzle openings lie, and is guided over the openings of the nozzles, which are arranged in series, and that there is a periodic emergence of adhesive particles onto the substrate web, a motion device advancing the substrate at a distance below the belt. Possible adhesives proposed include various formulations, such as hot-melt adhesives, pressure-sensitive adhesives or dispersion-based adhesives, composed of aqueous or organic systems, for example. Acrylate adhesives are proposed as suitable adhesive dispersions.

EP-A-621,289 describes the use of selected aqueous vinyl ester copolymer dispersions as adhesive bonding agents. These are emulsion polymers with 1-10% by weight of thermally crosslinkable comonomers. Typical copolymers are types based on vinyl acetate, ethylene, and N-methylolacrylamide. Nozzle application is described as one possible way of applying the adhesive to the substrate.

EP-A-1,113,031 discloses a process for the adhesive bonding of assembled paper sheets. Gluing can take place by means of nozzle application. The adhesive used is an aqueous dispersion of an anionic, modified polyurethane elastomer, such as a vinyl acetate-ethylene-polyurethane copolymer, for example.

DE-A-102 24 128 describes a selected process for the nozzle application of coatings to surfaces. Possible adhesives recommended are a very wide variety of types, examples being hotmelt adhesives, solution-based adhesives and dispersion-based adhesives.

EP-A-322,175 describes the emulsion polymerization of polyvinyl alcohol-stabilized vinyl esters together if desired with further comonomers, such as ethylene, acrylic acid or vinyl versatates, in the presence of selected, water-miscible chain transfer agents. The use of the products as adhesives is recommended, with one application method being nozzle application.

GB-A-1,438,993 discloses vinyl acetate-ethylene copolymers which are grafted with selected monomers. The products are recommended for use as hotmelt adhesives, solution-based adhesives and dispersion-based adhesives, with one application method being nozzle application.

EP-A-420,998 describes aqueous hotmelt adhesive suspensions or emulsions which derive from vinyl acetate and, if desired, further comonomers, such as ethylene, protective colloids, and emulsifiers, and which have been produced using a monomer-soluble initiator. These adhesives are suitable for spray application through nozzles.

WO-A-03/010,256 describes water-soluble or water-dispersible hotmelt adhesives which are prepared by graft copolymerization of selected olefinically unsaturated monomers, among them vinyl esters, onto polyalkylene oxides. One possible method of application recommended in addition to melt application is nozzle application.

EP-A-1,287,908 describes aqueous polymer dispersions for the spray application without the use of air. These include, among others, emulsifier-stabilized or protective-colloid-stabilized polyvinyl acetate dispersions and ethylene-vinyl acetate copolymer dispersions. Further details regarding the adhesive systems are not disclosed. This document does not reveal any reference to the suitability of these dispersions for application from high-speed nozzles and in the form of discrete regions on a substrate. The dispersions are used principally for impregnating the complete surface area of nonwovens.

EP-A-1,510,529 discloses a process for preparing multimodal polymer dispersions. It uses mixtures of selected protective colloids. At around 20 000 mPas (at 21° C.), the polymer dispersions described have comparatively high viscosities and are unsuitable for nozzle applications.

Under defined laboratory conditions after two hours, commercially customary dispersions exhibit a buildup of contamination on the nozzle of more than 4 mm up to the point of complete contamination. In practice this means that, in certain circumstances, it would be necessary to halt the machine for about five minutes several times a day in order to clean the nozzles, with a corresponding interruption to the production process.

Starting out from this prior art, the object of the present invention was to provide a nozzle application process in which an adhesive dispersion with advantageous physicochemical properties is used, with the consequence of a significantly more advantageous buildup behavior, preferably no buildup behavior.

Thus the plant downtimes should be considerably reduced. Under defined laboratory conditions there should also be distinctly reduced contamination: for example, after two hours, a buildup of contamination of <1 mm, in particular <0.5 mm.

This object is achieved through the use of selected dispersion-based adhesives for nozzle application, these adhesives, critically, being emulsifier-stabilized,

The present invention provides an application process for dispersion-based adhesives through nozzles to a substrate, wherein an aqueous, emulsifier-stabilized vinyl ester polymer dispersion having a solids content of at least 40% by weight and a viscosity of less than 8000 mPas is supplied to the nozzle and is applied from the nozzle, in the form of a thin jet or a predeterminedly interrupted thin jet, to the substrate, the vinyl ester polymer having a glass transition temperature of −30 to +40° C.

Vinyl ester polymer for the purposes of this description means a vinyl ester homopolymer or a vinyl ester copolymer.

The jet preferably has a diameter of less than 6 mm, more preferably a diameter of 0.1 to 2 mm.

The viscosity of the vinyl ester polymer dispersions used according to the invention is preferably 100 to 8000 mPas, more particularly 200 to 4000 mPas, and very preferably 400 to 3000 mPas. For the purposes of this description the viscosity measurement is made using the Brookfield viscometer at 23° C. and using spindle 5 at 23 revolutions per minute (rpm).

It will be appreciated that the dispersion can also be diluted further in order to be able to be employed at the nozzle. In that case there is a reduction in the solids content as well as the viscosity.

The polymers or copolymers of the dispersions used according to the invention have glass transition temperatures of typically −30 to +40° C., preferably from −30 to +15° C., with particular preference −20 to +10° C. In the case of heterogeneous systems such as, for example, core-shell or hemispheres, at least one glass transition temperature is between −30 to +40° C., preferably from −30 to +15° C., more preferably from −20 to +10° C. For the purposes of the present description, the glass transition temperature is determined by DSC measurement, with a heating rate of 10 K/minute.

For application, the vinyl ester polymer dispersion is applied to a substrate through nozzles. For that purpose the nozzle is supplied in conventional manner with the aqueous, emulsifier-stabilized vinyl ester polymer dispersion, which typically has a solids content of at least 40% by weight and a viscosity of less than 800 mpas, and the dispersion is applied from the nozzle, in the form of a continuous or predeterminately interrupted jet, to the substrate,

In accordance with the invention it is possible to use all nozzle application systems, more particularly systems having high switching frequencies of approximately up to 500 dots/second.

For example, the dispersion-based adhesive can be applied by means of HHS nozzle application systems from HHS, Krefeld. The valves involved may be D-valves or Vario-valves. These systems typically operate with the following technical data:

D-valves: glue pressure up to 35 bar; glue viscosity up to 2500 mpa*s; switching frequency up to 500/sec; and nozzle diameter 0.4 mm.

Vario-valves: glue pressure up to 6 bar; glue viscosity up to 500 mpa*s; switching frequency up to 1000/sec; and nozzle diameter 0.4 mm.

Further suitable nozzle application systems are the ECNS series systems from Robatech Glueing Technology. These systems typically have the following technical data: glue pressure 1-6 bar; glue viscosity max. 500 mpa*s; switching frequency max. 600/sec; and nozzle diameters 0.1-0.6 mm.

Further suitable nozzle application systems are the systems from ITW Dynatec Klebtechnik, Mettmann; from Reuther, Aichach; and from Nordson Deutschland GmbH, Erkrath.

By means of the nozzle application systems the aqueous, emulsifier-stabilized vinyl ester polymer dispersion is applied to the substrate in the form of a continuous or predeterminately interrupted jet. Application of the vinyl ester polymer dispersion is not spray application; instead, jets of adhesive, or sections of such jets, are applied to the substrate.

With the process of the invention, different geometries are possible for the vinyl ester dispersions applied to the substrate surface. Thus it is possible, for example, to produce predetermined patterns of adhesive dots or adhesive lines.

Substrates suitable are any desired materials that are to be joined to one another. These materials may have smooth, rough or porous surfaces and may take a variety of forms, flat materials being an example. In respect of the material as well there are no constraints imposed on the substrates. Examples of materials of which the substrates to be bonded may be composed are metals, plastics, paint surfaces, paper, textiles, nonwovens or natural substances, such as wood.

The substrates to be bonded may possess absorbent surfaces or hydrophobic surfaces. Examples of absorbent surfaces are papers, including paperboard and cardboard, and other fiber webs. Examples of hydrophobic surfaces are polymeric films (e.g., polyester film, polyolefin film such as polypropylene or polyethylene, for example, polystyrene film, acetate film) or papers with a UV varnish coating. Any desired combination may occur in practice.

The vinyl ester polymer dispersions used according to the invention are especially suitable for adhesives for nozzle application. In addition, the bonding properties can be controlled through the incorporation into the polymer of “soft” comonomers, such as ethylene or acrylates.

Surprisingly it has been found that, through the use of an aqueous vinyl ester polymer dispersion which is mainly stabilized with nonionic and/or ionic emulsifiers, it is possible to formulate dispersion-based adhesives having excellent nozzle running properties in respect of contamination buildup, without detriment to the bonding properties.

The vinyl ester polymer dispersions employed in accordance with the invention are prepared by free-radical emulsion polymerization of at least one vinyl ester monomer and are stabilized principally by means of emulsifiers. The monomer or monomer combination is selected such that the polymers or copolymers of the vinyl ester polymer dispersions employed in accordance with the invention have glass transition temperatures of typically −30 to +40° C., preferably −30 to +15° C., more preferably from −20 to +10° C. In the case of heterogeneous systems, such as core-shell or hemispheres, for example, at least one glass transition temperature moves within the abovementioned limits, whereas the glass transition temperature of the other phase can also move outside these limits.

Besides the vinyl ester monomer or vinyl ester monomers, the vinyl ester polymer employed in accordance with the invention may derive from further monomers copolymerizable therewith and containing at least one monoethylenically unsaturated group. Suitable monomers containing at least one monoethylenically unsaturated group are the free-radically polymerizable monomers that are known per se. They must be selected, however, so as to form vinyl ester polymers having the glass transition temperatures specified above.

Polymers with homogeneous and heterogeneous morphologies can be produced here.

Suitable vinyl ester monomers include, for example, vinyl esters of monocarboxylic acids having one to eighteen carbon atoms. These may be copolymerized preferably with aromatic and/or aliphatic α,β-unsaturated, unsubstituted or halogen-substituted hydrocarbons, such as ethene, propene, 1-butene, 2-butene, vinyl chloride, vinylidene chloride, styrene, α-methylstyrene, o-chlorostyrene, preference being given to ethene, and/or with acrylates and/or with methacrylates, such as alkyl acrylates and/or alkyl methacrylates, and/or with dialkyl esters of unsaturated dicarboxylic acids. Examples of particularly preferred vinyl esters are listed later on below.

The acrylate and/or methacrylate comonomers may be esters of alcohols having one to eighteen carbon atoms, such as methyl methacrylate or acrylate, butyl methacrylate or acrylate, 2-ethylhexyl methacrylate or acrylate; the aromatic and/or aliphatic α,β-unsaturated, unsubstituted or halogen-substituted hydrocarbon comonomers may be ethene, propene, 1-butene, 2-butene, vinyl chloride, vinylidene 30 chloride, styrene, α-methylstyrene or o-chlorostyrene, preference being given to ethene.

Particular preference is given to using vinyl ester copolymers which derive from combinations of “hard” and “soft” monomers. By “hard” monomers are meant compounds whose homopolymers have a glass transition temperature of greater than 30° C.; by “soft” monomers are meant compounds whose homopolymers have a glass transition temperature of less than or equal to 30° C.

Examples of hard monomers are methyl methacrylate, vinyl acetate, vinyl 1-methylcyclohexanoate, isobornyl acrylate, isobornyl methacrylate, vinyl esters of an α-branched carboxylic acid having 9 carbon atoms in the acid radical (VeoVa 9), vinyl benzoate, vinyl phenylisobutanoate, vinyl phenylpropionate, vinyl tert-butylbenzoate, vinyl cyclohexanoate, vinyl toluoate, N-vinylformamide, dimethyl maleate, di-tert-butyl maleate, dicyclohexyl maleate, isopropenyl acetate, vinyl chloride, and acrylonitrile.

Examples of soft monomers are butyl acrylate, 2-ethylhexyl acrylate, ethylene, lauryl acrylate, vinyl laurate, vinyl esters of an α-branched carboxylic acid having 10 or 11 carbon atoms in the acid radical (VeoVa 10 or VeoVa 11) or vinyl 2-ethylhexanoate.

The stated vinyl ester, acrylate, methacrylate, unsaturated dicarboxylic diester, aromatic or aliphatic α,β-unsaturated hydrocarbon monomers generally form the principal monomers of the vinyl ester polymer dispersions used according to the invention, which in terms of the total amount of the monomers to be polymerized by the process of free-radical aqueous polymerization, normally make up a fraction of more than 40% by weight.

As a general rule these monomers are only of moderate to low solubility in water under standard conditions (25° C., 1 atm).

It will be appreciated that further comonomers which modify the properties in a specific way may be added. Such monomers are normally copolymerized only as modifying monomers, in amounts, based on the total amount of the monomers to be polymerized, of less than 20% by weight, generally 0.1% to 20%, preferably 0.3% to 10% by weight.

Monomers which typically increase the internal strength of films of the aqueous polymer vinyl ester dispersions normally contain at least one epoxy, hydroxyl, N-methylol or carbonyl group, or at least two nonconjugated ethylenically unsaturated double bonds.

Particularly advantageous in this case are the diesters of dihydric alcohols with α,β-monoethylenically unsaturated monocarboxylic acids, among which acrylic and methacrylic acid are preferred.

Of particular significance in this context also are the methacrylic and acrylic C₁-C₉ hydroxyalkyl esters, such as n-hydroxyethyl, n-hydroxypropyl or n-hydroxybutyl acrylate and methacrylate, and also compounds such as diacetone acrylamide and acetylacetoxyethyl acrylate and methacrylate

Particular preference is given to using a vinyl ester copolymer which has been prepared by free-radical emulsion polymerization and that contains at least 40 mol %, based on the total amount of the monomers employed, of vinyl ester monomer or mixture of vinyl ester monomers.

One aqueous vinyl ester copolymer dispersion that is particularly preferably used in accordance with the invention derives from at least one vinyl ester copolymer obtained by emulsion polymerization of at least one vinyl ester of an aliphatic carboxylic acid and at least one monomer copolymerizable therewith in the presence of at least one nonionic emulsifier and/or of at least one anionic emulsifier and, if desired, of at least one molecularly or dispersely water-soluble polymer.

Emulsifiers employed with preference here are nonionic emulsifiers having alkylene oxide groups and/or anionic emulsifiers having sulfate, sulfonate, phosphate and/or phosphonate groups, which if desired are used together with molecularly or dispersely water-soluble polymers, preferably together with polyvinyl alcohol.

Particularly preferably used vinyl ester copolymers derive from
A1) vinyl esters of aliphatic, saturated carboxylic acids having a chain length of C₁-C₄,
A2) alpha-olefins having 2 to 8 carbon atoms, and/or
A3) vinyl esters of aliphatic, saturated carboxylic acids having a chain length of C₅-C₁₈, more particularly vinyl esters of α-branched carboxylic acids having 5 to 11 carbon atoms in the acid radical (®Versatic acids),
A4) if desired, esters of ethylenically unsaturated monocarboxylic or dicarboxylic acids, more particularly of acrylic acid and/or of methacrylic acid and/or of maleic acid, with monohydric saturated alcohols, more particularly butyl acrylate (BuA) and/or 2-ethylhexyl acrylate (2-EHA) and/or dibutyl maleate and/or dioctyl maleate, and also
A5) if desired, further comonomers which do not fall within one of groups A1 to A4), the sum of the monomers of types A1, A2 and/or A3 and/or, if desired, A4 and/or, if desired, A5 making 100% by weight.

Particularly preferably used vinyl ester copolymers derive from monomers of types A1, A2 and/or, if desired, A4) or A1, A3 and/or, if desired, A4) or, preferably, from monomers of types A1, A2, A3 and/or, if desired, A4).

The vinyl esters A1 of aliphatic saturated carboxylic acids of chain length C₁-C₄ are vinyl esters of linear or branched aliphatic carboxylic acids, examples being vinyl formate, vinyl acetate, vinyl propionate, vinyl butyrate or vinyl isobutyrate. Vinyl acetate is preferred. In the polyvinyl esters the vinyl esters Al may also be present in a combination of two or more thereof alongside one another.

The fraction of the monomers A1, where appropriate in combination with further comonomers from this group, is 40% to 95% by weight, preferably 50% to 80% by weight, based on the total amount of the monomers employed.

The alpha-olefins having 2 to 8 carbon atoms, A2, are branched or linear alpha-olefins, examples being prop-1-ene, but-1-ene, pent-1-ene, hex-1-ene, hept-1-ene, oct-1-ene, and in particular, ethylene.

The fraction of the monomers A2, where appropriate in combination with further comonomers from this group, is 0% to 45% by weight, preferably 5% to 45% by weight, more preferably 8% to 30% by weight, very preferably 12% to 28% by weight, based on the total amount of the monomers employed.

The vinyl esters A3 of aliphatic saturated carboxylic acids of chain length C₅-C₁₈ are vinyl esters of linear or, preferably, of branched aliphatic carboxylic acids, examples being vinyl esters of a-branched carboxylic acids having 5 to 11 carbon atoms in the acid radical (®Versatic acids), the vinyl esters of pivalic, 2-ethylhexanoic, lauric, paimitic, myristic, and stearic acid. Vinyl esters of Versatic acids, more particularly VeoVa® 9, VeoVa® 10, and VeoVa® 11, are preferred. In the polyvinyl ester the vinyl esters A3 may also be present in a combination of two or more thereof alongside one another.

The fraction of the monomers A3, where appropriate in combination with further comonomers from this group, is 0% to 60% by weight, preferably 0% to 40% by weight, more preferably 0% to 30% by weight, very preferably 0% to 25% by weight, based on the total amount of the monomers employed.

Suitable comonomers of group A4 which can be used in the copolymer are comonomers which can be used to tailor the adhesion properties. They include, primarily, esters of ethylenically unsaturated monocarboxylic or dicarboxylic acids with monohydric saturated alcohols, more particularly esters of acrylic, methacrylic and/or maleic acid with aliphatic C₁-C₈ monoalcohols, more particularly (meth)acrylic esters or maleic esters with monohydric aliphatic saturated alcohols of chain length C₄-C_{8.} Examples of particularly preferred monomers of this type are butyl acrylate, 2-ethylhexyl acrylate, dibutyl maleate and/or dioctyl maleate.

The fraction of the monomers A4, where appropriate in combination with further comonomers from this group, is 0% to 45% by weight, preferably 0% to 40% by weight, more preferably 0% to 30% by weight, very preferably 0% to 20% by weight, based on the total amount of the monomers employed.

Suitable comonomers of group A5 preferably possess at least one stabilizing nonionic or ionic group, preferably an acid group or an OH group in the molecule, which stabilize the emulsion polymer additionally via polymer-bonded functional groups and/or charges.

Particularly suitable comonomers A5 with stabilizing nonionic groups are esters of ethylenically unsaturated aliphatic monocarboxylic and/or dicarboxylic acids with polyalkylene glycols, preferably with polyethylene glycols and/or polypropylene glycols, or esters of ethylenically unsaturated carboxylic acids with amino alcohols, such as (meth)acrylic esters of amino alcohols, such as of diethylaminoethanol, for example, and/or (meth)acrylic esters with dimethylaminoethanol, and also (meth)acrylic esters with dihydric aliphatic alcohols of chain length C₂-C₁₈ in which only one alcohol group has been esterified. Also suitable are amides of ethylenically unsaturated carboxylic acids, such as amides of acrylic and methacrylic acid, and N-methylol amides of acrylic and methacrylic acid, and their ethers. A further group of these monomers are N-vinyl amides, including the N-vinyl lactams, such as vinyl pyrrolidone or N-vinyl-N-methylacetamide, for example.

Suitable comonomers A5 having stabilizing ionic groups are ethylenically unsaturated carboxylic acids or sulfonic acids which have one or two carboxyl groups or one sulfonic acid group. In place of the free acids it is also possible to use their salts, preferably alkali metal salts or ammonium salts.

Examples thereof are acrylic acid, methacrylic acid, crotonic acid, maleic acid, fumaric acid, itaconic acid, vinylsulfonic acid, styrenesulfonic acid, monoesters of maleic and/or fumaric acid, and of itaconic acid, with monohydric aliphatic saturated alcohols of chain length C₁-C₁₈, and also their alkali metal salts and ammonium salts, or (meth)acrylic esters of sulfoalkanols, an example being sodium 2-sulfoethyl methacrylate.

Further comonomers A5 which can be used to tailor the adhesion properties are ethylenically unsaturated silanes. These are, typically, monomers of the general formula RSi(CH₃)₀₋₂(OR¹)₃₋₁, in which R has the definition CH₂=CR²-(CH₂)₀₋₁ or CH₂=CR²CO₂-(CH₂)₁₋₃, R¹ is a branched or unbranched, unsubstituted or substituted alkyl radical having 1 to 12 carbon atoms, which if appropriate may be interrupted by an ether group, and R² is H or CH₃.

As further comonomers A5 which can be used in the vinyl ester copolymer it is possible to employ any desired comonomers which do not belong to groups A1, A2, A3 or A4. Examples of such are esters of aliphatic carboxylic acids of chain length C₃-C₁₂ with unsaturated alcohols of chain length C₃-C₁₈, vinyl chloride, vinylidene chloride, acrylonitrile and methacrylonitrile, butadiene, isoprene, C₉-C₁₆ alpha-olefins, 2-chlorobutadiene, 2,3-dichlorobutadiene, tetrafluoroethylene, styrene, vinyl ethers of monohydric aliphatic saturated alcohols of chain length C₁-C₁₈, divinyl and diallyl esters of saturated and unsaturated aliphatic dicarboxylic acids of chain length C₃-C₁₈, vinyl and allyl esters of acrylic acid and crotonic acid, triallyl cyanurate, and ethylenically unsaturated epoxide compounds, such as glycidyl methacrylate or glycidyl acrylate.

Preferred as further comonomers A5 are C₁₄-C₁₆ alpha-olefins or butadiene or ethylenically unsaturated epoxide compounds.

The amount of the further comonomers A5 where present, where appropriate in combination with further comonomers from this monomer group, is typically up to 10% by weight, preferably up to 8% by weight, based on the overall copolymer composition A).

In the polyvinyl ester the comonomers A5 may also be present in a combination of two or more thereof alongside one another.

Preference is given to using dispersions comprising polyvinyl acetate-ethylene copolymers, which in particular contain between 12 and up to 40 parts by weight of ethylene.

Another preferably used variant of dispersions comprises vinyl acetate-ethylene copolymers which additionally contain, in copolymerized form, 0.5 to 40 parts by weight of esters of acrylic acid and/or of esters of methacrylic acid and/or of diesters of maleic acid with monohydric saturated alcohols, more particularly butyl acrylate (BuA) and/or 2-ethylhexyl acrylate (2-EHA) and/or dibutyl maleate and/or dioctyl maleate.

Preferred monomer combinations for preparing vinyl ester copolymers are vinyl acetate/ethylene, vinyl acetate/vinyl esters of a-branched carboxylic acids having 5 to 11 carbon atoms in the acid radical, vinyl acetate/dibutyl maleate, vinyl acetate/dioctyl maleate, vinyl acetate/2-ethylhexyl acrylate, vinlyl acetate/butyl acrylate, vinyl acetate/ethylene/butyl acrylate, and vinyl acetate/ethylene/2-ethylhexyl acrylate.

The solids fraction of the aqueous vinyl ester polymer dispersions preferably used according to the invention is typically 40% to 70% by weight, preferably 45% to 60% by weight, based on the overall solids content, more preferably between 50% and 55%.

The vinyl ester polymer dispersion employed in accordance with the invention comprises nonionic emulsifiers E1 and/or anionic emulsifiers E2, the nonionic emulsifiers being preferred. The vinyl ester polymer dispersion may further comprise small amounts of polymeric stabilizers (protective colloids).

Examples of nonionic emulsifiers E1 are acyl, alkyl, oleyl, and alkylaryl oxethylates. These products are commercially available, for example, under the name Genapol®, Lutensol® or Emulan®. They include, for example, ethoxylated mono-, di-, and tri-alkylphenols (EO degree: 3 to 50, alkyl substituent radical: C₄ to C₁₂) and also ethoxylated fatty alcohols (EO degree: 3 to 80; alkyl radical: C₈ to C₃₆), especially C₁₂-C₁₄ fatty alcohol (3-40)ethoxylates, C₁₃C₁₅ oxo-process alcohol (3-40)ethoxylates, C₁₆C₁₈ fatty alcohol (11-80)ethoxylates, C₁₀ oxo-process alcohol (3-40)ethoxylates, C₁₃ oxo-process alcohol (3-40)ethoxylates, polyoxyethylenesorbitan monooleate with 20 ethylene oxide groups, copolymers of ethylene oxide and propylene oxide having a minimum ethylene oxide content of 10% by weight, the polyethylene oxide(4-40) ethers of oleyl alcohol, and the polyethene oxide(4-40) ethers of nonylphenol. Particularly suitable are the polyethylene oxide(4-40) ethers of fatty alcohols, more particularly of oleyl alcohol, stearyl alcohol or C11 alkyl alcohols.

The amount of nonionic emulsifiers E1 used is typically 1% to 6.0% by weight, preferably 2% to 5.0% by weight, more preferably 2% to 4.5% by weight, based on the polymer. Mixtures of nonionic emulsifiers can also be employed.

Examples of anionic emulsifiers E2 are sodium, potassium, and ammonium salts of linear aliphatic carboxylic acids of chain length C₁₂-C_{20,} sodium hydroxyoctadecanesulfonate, sodium, potassium, and ammonium salts of hydroxy fatty acids of chain length C₁₂-C₂₀ and their sulfonation and/or sulfation and/or acetylation products, alkyl sulfates, including those in the form of triethanolamine salts, alkyl(C₁₀-C₂₀)sulfonates, alkyl(C₁₀-C₂₀)arylsulfonates, dimethyl-dialkyl (C₈-C₁₈)ammonium chloride, and their sulfonation products, lignosulfonic acid and its calcium, magnesium, sodium, and ammonium salts, resin acids, hydrogenated and dehydrogenated resin acids, and their alkali metal salts, dodecylated sodium diphenyl ether disulfonate, sodium lauryl sulfate, ethoxylated sodium lauryl ether sulfate (EO degree 3) or a salt of a bisester, preferably of a bis-C₄-C₁₈ alkyl ester, of a sulfonated dicarboxylic acid having 4 to 8 carbon atoms, or a mixture of these salts, preferably sulfonated salts of esters of succinic acid, more preferably salts, such as alkali metal salts, of bis-C₄-C₁₈ alkyl esters of sulfonated succinic acid.

The amount of anionic emulsifiers E2 used is typically 0.1% to 3.0% by weight, preferably 0.1% to 2.0% by weight, more preferably 0.5% to 1.5% by weight, based on the polymer. Mixtures of anionic emulsifiers can also be employed.

Mixtures of nonionic and anionic emulsifiers can also be employed. The weight fraction of emulsifiers E1 to E2 may fluctuate within wide ranges, between 50:1 and 1:1 for example.

In addition to the emulsifiers and, if appropriate, protective colloids that are used during the emulsion polymerization it is additionally possible to have the vinyl ester polymer dispersions used according to the invention containing subsequently added water-soluble or water-dispersible polymers and/or subsequently added emulsifiers too.

The total fraction of emulsifiers, based on the polymer, is typically 0.5% to 7% by weight, preferably 1% to 6.0% by weight, more preferably 1% to 5% by weight.

Besides emulsifiers, the vinyl ester polymer dispersions employed in accordance with the invention may comprise protective colloids, preferably polyvinyl alcohols and/or their modifications. Protective colloids—if present—are generally present only in comparatively low concentrations, as for example at up to 2% by weight, based on the total amount of the monomers used. The vinyl ester polymer dispersions employed in accordance with the invention preferably contain no protective colloids or up to 1% by weight of protective colloids, based on the total amount of the monomers employed.

The protective colloids are water-soluble or water-dispersible polymers which are present during the emulsion polymerization and stabilize the dispersion as it forms. Emulsifiers are low molecular weight compounds which stabilize the emulsion and also the product formed.

Examples of protective colloids are water-soluble or water-dispersible polymeric modified natural substances, such as cellulose ethers, examples being methyl-,ethyl-, hydroxyethyl- or carboxymethylcellulose; water-soluble or water-dispersible polymeric synthetic substances, such as polyvinyl alcohols or their copolymers (with or without residual acetyl content), and polyvinyl alcohol which is partially esterified or acetalized or etherified with saturated radicals.

The protective colloids can be used individually or in combination. In the case of combinations they each differ in their molecular weights or they differ in their molecular weights and in their chemical composition, such as the degree of hydrolysis, for example.

In the case of polyvinyl alcohol as protective colloid, rather than stating the molecular weight, it is preferred to specify the viscosity of a 4% strength aqueous solution at 20° C. (measured using the Höppler viscometer).

Particularly suitable polyvinyl alcohol possesses preferably a degree of hydrolysis of 70 to 100 mol % and/or its aqueous solution possesses a viscosity at 25° C. of 2 to 60 mPa*s.

These viscosity figures and those given below refer in each case to measurements using the Höppler viscometer.

Further suitable polyvinyl alcohols may have been hydrophobically or hydrophilically modified in any way.

Where appropriate, the aqueous vinyl ester polymer dispersions used according to the invention further comprise additional additions which are typical per se in the formulation of dispersion-based adhesives.

These include, for example, film-forming assistants, such as white spirit, Texanol®, TxiB®, butyl glycol, butyldiglycol, butyldipropylene glycol, and butyltripropylene glycol; plasticizers, such as dimethyl phthalate, diisobutyl phthalate, diisobutyl adipate, Coasol B®, Plastilit 3060®, and Triazetin®; wetting agents, such as AMP 90®, TegoWet.280®, Fluowet PE®; thickeners, such as polyacrylates or polyurethanes, such as Borchigel L75® and Tafigel PUR 60®; defoamers, such as mineral oil defoamers or silicone defoamers; UV protectants, such as Tinuvin 1130®, subsequently added stabilizing polymers, such as polyvinyl alcohol or cellulose ethers, and other additives and auxiliaries of the kind typical for the formulation of adhesives.

The fraction of these additions in the dispersion-based adhesive used according to the invention can be up to 25% by weight, preferably 2% to 15% by weight, and in particular 5% to 10% by weight, based on the dispersion.

The vinyl ester polymer dispersions employed in accordance with the invention are prepared by free-radical emulsion polymerization of at least one vinyl ester monomer and, if desired, further monomers containing at least one ethylenically unsaturated group, in the presence of at least one emulsifier. Examples thereof have been listed above.

The preparation of aqueous polymer dispersions has already been described in numerous instances and is therefore known to the skilled worker [cf., e.g., Encyclopedia of Polymer Science and Engineering, vol. 8, p. 659 ff (1987)].

In general the addition of the monomers takes place by continuous feed; alternatively it is possible to include a large portion of the monomers, e.g. up to 70% by weight in the initial charge.

The polymerization may also be carried out in a manner known per se in two or more stages with different monomer combinations, giving polymer dispersions having particles with heterogeneous morphology.

The polymerization of the ethylenically unsaturated monomers takes place in the presence of at least one initiator for the free-radical polymerization of the ethylenically unsaturated monomers.

Suitable initiators for the free-radical polymerization, for initiating and continuing the polymerization during the preparation of the dispersions, include all known initiators which are capable of initiating a free-radical, aqueous polymerization in heterophase systems.

These initiators may be peroxides, such as alkali metal and/or ammonium peroxodisulfates, or azo compounds, more particularly water-soluble azo compounds.

As polymerization initiators it is also possible to use what are called redox initiators. Examples thereof are tert-butyl hydroperoxide and/or hydrogen peroxide in combination with reducing agents, such as with sulfur compounds, an example being the sodium salt of hydroxymethanesulfinic acid, Brüggolit FF6 and FF7, Rongalit C, sodium sulfite, sodium disulfite, sodium thiosulfate, and acetone-bisulfite adduct, or with ascorbic acid or with reducing sugars.

The amount of the initiators or initiator combinations used in the process varies within what is usual for aqueous polymerizations in heterophase systems In general the amount of initiator used will not exceed 5% by weight, based on the total amount of the monomers to be polymerized.

The amount of initiators used, based on the total amount of the monomers to be polymerized, is preferably 0.05% to 2.0% by weight.

In this context it is possible for the total amount of initiator to be included in the initial charge at the beginning of the polymerization; preferably, alternatively, a portion of the initiator is included in the initial charge at the beginning, and the remainder is added after the polymerization has been initiated, in one or more steps or continuously. The addition may be made separately or together with other components, such as emulsifiers.

The molecular weight of the polymers of the aqueous vinyl ester polymer dispersions can be adjusted by adding small amounts of one or more molecular weight regulator substances. These regulators, as they are known, are generally used in an amount of up to 2% by weight, based on the monomers to be polymerized. As regulators it is possible to use all of the substances known to the skilled worker. Preference is given, for example, to organic thio compounds, silanes, allyl alcohols, and aldehydes.

The aqueous vinyl ester polymer dispersion may further comprise a range of additional substances, such as plasticizers, preservatives, agents for adjusting the pH and/or defoamers, for example.

The polymerization temperature is generally 20 to 150° C. and preferably 50 to 100° C.

The polymerization takes place under pressure if appropriate, preferably 10-150 bar, more preferably 30 to 95 bar.

Following the polymerization reaction proper it may be desirable and/or necessary largely to free the resultant aqueous vinyl ester polymer dispersion from odorous substances, such as residual monomers and other volatile organic constituents, for example. This can be done in a manner known per se, physically for example, by distillative removal (in particular via steam distillation) or by stripping with an inert gas. A further possibility is also to reduce the residual monomer content chemically, by means of free-radical post-polymerization, more particularly by exposure to redox initiator systems, as described, for example in DE-A-4,435,423. Preference is given to a post-polymerization with a redox initiator system made up of at least one organic peroxide and also one organic and/or inorganic sulfite and/or sulfinic acid derivatives.

Particular preference is given to a combination of physical and chemical methods, where after the residual monomer content has been lowered by chemical post-polymerization the further lowering of the residual monomer content is accomplished by means of physical methods, to preferably <2000 ppm, more preferably <1000 ppm, in particular <100 ppm.

The polymerization is typically carried out at a pH in the region of less than/equal to 9. To adjust the pH of the vinyl ester polymer dispersion it is possible in principle to use buffer systems, such as sodium acetate, for example, or phosphate buffer systems.

Preferably a pH range of 2 to 9 is favorable, a preferred pH being in the range between 3 and 8.

The solids content of the polyvinyl ester copolymer dispersions used according to the invention is at least 40% by weight, preferably between 45% and 60% by weight, and with particular preference between 50% and 55%. The weight figures here are based on the total mass of the dispersion.

The invention also relates to the use of the above-described polyvinyl ester dispersion for nozzle application to substrates.

Application may take place in discrete surface sections or, preferably, dotwise or linearly.

The dispersion-based adhesives are used preferably for the adhesive bonding of coated or uncoated paper in the production-line fabrication of folding boxes, envelopes, brochures, and cigarettes, more particularly for producing paper/paper bonds (coated and uncoated) or paper/polymeric film bonds.

These uses are likewise provided by the present invention.

The examples below illustrate the invention without limiting it.

Measurement Methods

Measuring the Particle Size Distribution

The particle size distribution was measured using the Mastersizer Micro Plus laser diffraction instrument from Malvern. The scatter data were evaluated using the volume-averaged “polydisperse Mie” evaluation provided by Malvern.

Glass Transition Temperature

The glass transition temperature was measured using a Mettler DSC 820 at 20 K/min. Evaluation was carried out on the second heating curve.

### EXAMPLE 1

### Preparing a Polymer Dispersion with Heterogeneous Morphology

A pressure apparatus with stirrer, jacket heating, and metering pumps was charged with an aqueous solution consisting of the following constituents:

| | | |
|---|---|---|
| 24937 | g | DI water (deionized water) |
| 1173 | g | Celvol ® 523 solution (15% in DI water, polyvinyl |
| | | alcohol from Celanese) |
| 85 | g | sodium acetate (anhydrous) |
| 591 | g | sodium ethenesulfonate (30% form) |
| 1478 | g | Emulsogen ® EPN 287 (70% in DI water, ethoxylate-based |
| | | nonionic emulsifier from Clariant) |
| 1150 | g | Texapon ® K 12/15 (15% in DI water, sodium dodecyl |
| | | sulfate from Cognis) |
| 13.4 | g | sodium disulfite |
| 8 | g | Mohr salt |

The polyvinyl alcohol was dissolved beforehand in each case in a 15% strength solution at 90° C. for 2 hours. The apparatus was freed from atmospheric oxygen. 5% of the amount of vinyl acetate (total amount: 28972 g) was metered into the reactor. The ethylene valve was opened and 6.8% of ethylene (total amount 5519 g) was injected. At the same time the temperature was raised to 65° C. At 55° C. the initiator 1 (71 g of sodium peroxodisulfate in 710 g of Dl water) was metered in rapidly. When 65° C. was reached, 27.5% of vinyl acetate was metered in over 60 minutes and 67.5% of vinyl acetate over 300 minutes. After 105 minutes of the vinyl acetate metering the ethylene pressure was raised over the course of 60 minutes to 50 bar. When all of the ethylene was in the reactor, the ethylene valve was closed. After 310 minutes the batch was heated over the course of 50 minutes to 85° C. and was held at that temperature for 1 hour. In the course of heating, during the 50 minutes, an initiator solution 2 (34.5 g of sodium peroxodisulfate in 1183 g of Dl water) was metered in. Thereafter the batch was cooled. Subsequently a redox treatment and/or a physical treatment was carried out in order to reduce the residual monomers.

Characteristic data of example dispersion 1

| | |
|---|---|
| dry matter: | 55% |
| pH (electrode measurement): | 5 |
| Brookfield viscosity (23° C., | 6400 mPas |
| spindle 5, 20 rpm): | |
| residual monomer content: | <0.2% |
| glass transition temperature of polymer | 2 stages: −4 and 21° C. |
| (20 K/min): | |
| particle size distribution (Mastersizer, | d_{w} = 340 nm |
| polydisperse, Mie): | d_{w}/dₙ = 1.13 |

### EXAMPLE 2

### Preparing a Homogenous Polymer Dispersion

A pressure apparatus with stirrer, jacket heating, and metering pumps was charged with an aqueous solution consisting of the following constituents:

| | | |
|---|---|---|
| 25176 | g | DI water (deionized water) |
| 1173 | g | Celvol ® 523 solution (15% in DI water, polyvinyl |
| | | alcohol from Celanese) |
| 85 | g | sodium acetate (anhydrous) |
| 591 | g | sodium ethenesulfonate (30% form) |
| 1478 | g | Emulsogen ® EPN 287 (70% in DI water, ethoxylate-based |
| | | nonionic emulsifier from Clariant) |
| 1150 | g | Texapon ® K 12/15 (15% in DI water, sodium dodecyl |
| | | sulfate from Cognis) |
| 13.4 | g | sodium disulfite |
| 8 | g | Mohr salt |

The polyvinyl alcohol was dissolved beforehand in each case in a 15% strength solution at 90° C. for 2 hours. The apparatus was freed from atmospheric oxygen. 7% of the amount of vinyl acetate (total amount: 28974 g) was metered into the reactor. The ethylene valve was opened and the pressure adjusted to 50 bar (total amount: 5519 g). At the same time the temperature was raised to 65° C. At 60° C. and 45 bar ethylene pressure the initiator 1 (71 g of sodium peroxodisulfate in 474 g of Dl water) was metered in rapidly. When 65° C. was reached, 27.5% of vinyl acetate was metered in over 60 minutes and 67.5% of vinyl acetate over 300 minutes. When all of the ethylene was in the reactor, the ethylene valve was closed. After 310 minutes the batch was heated over the course of 50 minutes to 85° C. and was held at that temperature for 1 hour. In the course of heating, during the 50 minutes, an initiator solution 2 (34.5 g of sodium peroxodisulfate in 1183 g of Dl water) was metered in. Thereafter the batch was cooled. Subsequently a redox treatment and/or a physical treatment was carried out in order to reduce the residual monomers.

Characteristic data of example dispersion 2

| | |
|---|---|
| dry matter: | 54% |
| pH (electrode measurement): | 4 |
| Brookfield viscosity (23° C., spindle 5, 20 rpm): | 6500 mPas |
| residual monomer content: | <0.2% |
| glass transition temperature of polymer (20 K/min): | 4° C. |
| particle size distribution (Mastersizer, polydisperse, Mie): | d_{w} = 410 nm |
| | d_{w}/dₙ = 2.16 |

### EXAMPLE 3

### Preparing a Further Homogeneous Polymer Dispersion

The procedure of example 2 was repeated, but without addition of polyvinyl alcohol.

Characteristic data of example dispersion 3

| | |
|---|---|
| dry matter: | 54% |
| pH (electrode measurement): | 4 |
| Brookfield viscosity (23° C., spindle 5, 20 rpm): | 4500 mPas |
| residual monomer content: | <0.2% |
| glass transition temperature of polymer (20 K/min): | 4° C. |
| particle size distribution (Mastersizer, polydisperse, Mie): | d_{w} = 370 nm |
| | d_{w}/dₙ = 1.50 |

### EXAMPLE 4 (comparative)

Commercial VAE (vinyl acetate-ethylene) dispersion stabilized with polyvinyl alcohol.

Characteristic data of comparative dispersion 4

| | |
|---|---|
| dry matter: | 55% |
| pH (electrode measurement): | 4 |
| Brookfield viscosity (23° C., spindle 5, 20 rpm): | 4000 mPas |
| residual monomer content: | <0.2% |
| glass transition temperature of polymer (20 K/min): | 7° C. |
| particle size distribution (Mastersizer, polydisperse, Mie): | d_{w} = 860 nm |
| | d_{w}/dₙ = 2.26 |

### EXAMPLE 5

### Nozzle Application and Adhesive Properties

1. Buildup

Application to a high-speed conveyor belt was simulated in the laboratory by application to a stainless steel roller rotating at high speed. The roller had a diameter of approximately 26 cm and was rotated with a speed of 100 m/min. Located vertically above the roller was a device having 3 glue application nozzles. These nozzles were supplied with the adhesive by means of a hoseline system via a piston pump (pressure 5-40 bar; 10 bar were used in the tests). The distance between the nozzle and the roller was 4 mm. The glue application nozzles (e.g., hhs, D-valve) were driven via an electronic control unit. The simulation was carried out at the profile of the side-seam bonding of a folding box 12 cm long. 12 glue dots were applied in a row. The open time of the valve was 4 ms, and the closed time between 2 dots was 2 ms. The total time for a row with a total of 12 glue dots was therefore 70 ms.

A sequence consisted of 4 rows, with a pause of 55.3 ms between the individual rows (to simulate the distance between 2 substrates on the conveyor belt). Between 2 sequences there was a pause of 165.6 ms.

This profile was run over a time of 2 hours, and at 15-minute intervals the stalactitic buildup on the nozzle was measured by means of digital image analysis. For these measurements the dispersion was diluted to the point where it exhibited a viscosity of 1000 mPas. The result is the buildup in mm over the time in minutes.

2. Tailing

The tailing was determined by digital image analysis of the drops applied to the stainless steel roller, using a high-speed camera. Application in the case of this experiment was in principle similar to that described under 1, except that the running speed of the roller was 250 m/min and the distance between the nozzle and the roller was 10 mm. The cycle sequence of the nozzle was 4 ms for one glue dot and 3.4 ms between 2 glue dots. The result reports the drop measured in the lengthwise direction from the “ahead” to the “tail”.

3. Manual Setting Rate

3.1 Using a slotted coating bar (50 μm wet film), the adhesive is applied to the glazed side of a piece of cardboard cut to a length of 40 cm and a width of 10 cm, e.g., GD1 Juwel Top (250 g/m²), which had been provided with a cm scale.

3.2 Directly after the application of the adhesive, a strip of paper cut to a length of 55 cm and a width of 5 cm, e.g., kraft paper (80 g/m²), was placed on the film of adhesive and adhered by pressing down using a manual roller.

3.3 Immediately after the completion of the bond, the paper strip was peeled from the card by hand at a speed of about 1 cm/s until clearly visible fiber extraction occurred.

3.4 of the scaling on the cardboard strip it was now possible to correlate the distance traveled to the beginning of fiber extraction with a time (1 cm corresponds to 1 s). This figure corresponded to the setting time of the adhesive, and was reported.

TABLE 1
Results

| | | | Adhesive | Particle size | |
|---|---|---|---|---|---|
| Dispersion | Behavior at the nozzle | | properties | distribution | |
| from | buildup | tailing | manual setting | d_{w} | |
| example | (mm/h) | (mm) | rate(s) | (nm) | d_{w}/dₙ |
| 1 | 0 (after | 13.7 | 20 | 340 | 1.13 |
| (inventive) | 120 min) | | | | |
| 2 | 0 (after | 14.0 | 19 | 410 | 2.16 |
| (inventive) | 120 min) | | | | |
| 3 | 0 (after | 13.8 | 18 | 370 | 1.50 |
| (inventive) | 120 min) | | | | |
| 4 | 4 (nozzle | 14.6 | 18 | 860 | 2.26 |
| (comparative) | clogged) | | | | |

The examples 1, 2 and 3 showed virtually no buildup at the nozzle, whereas the case of the reference dispersion the buildup after just 1 hour had reached the maximum length of 4 mm and was touching the roller. The tailing is comparable. The adhesive properties are unaffected in the inventive examples and are of a comparable quality to those of commercially customary VAE dispersions.

1-21. (canceled)

22. A process for applying a dispersion-based adhesive through nozzles to a substrate comprising (1) supplying an aqueous, emulsifier-stabilized, vinyl ester polymer dispersion having a solids content of at least 40% by weight and a viscosity of less than 8000 mPas to a nozzle and (2) applying said dispersion from the nozzle to the substrate in the form of a thin jet or a predeterminedly interrupted thin jet, wherein said vinyl ester polymer has a glass transition temperature of −30 to 40° C.

23. The process of claim 22, wherein said substrate is a two-dimensional substrate having coating-material surfaces.

24. The process of claim 22, wherein said substrate is a two-dimensional substrate having at least one absorbent surface.

25. The process of claim 23, wherein said substrate is two-dimensional and flexible, and wherein paper/paper or paper/polymeric film adhesive bonds are produced.

26. The process of claim 22, wherein said vinyl ester polymer has a glass transition temperature of −30 to 15° C.

27. The process of claim 22, wherein said dispersion has a viscosity of 200 to 4000 mPas.

28. The process of claim 22, wherein said dispersion comprises at least one vinyl ester copolymer obtained by emulsion polymerization of at least one vinyl ester of an aliphatic carboxylic acid and at least one monomer copolymerizable therewith in the presence of at least one nonionic emulsifier having alkylene oxide groups and/or at least one anionic emulsifier having sulfate, sulfonate, phosphate, and/or phosphonate groups, and optionally in the presence of a molecularly or dispersely water-soluble polymer.

29. The process of claim 22, wherein said dispersion comprises at least one vinyl ester copolymer obtained by emulsion polymerization of at least one vinyl ester of an aliphatic carboxylic acid and at least one monomer copolymerizable therewith in the presence of at least one nonionic emulsifier and/or of at least one anionic emulsifier and 0% to 2% by weight, based on the total amount of the monomers, of at least one polyvinyl alcohol.

30. The process of claim 22, wherein said dispersion comprises at least one vinyl ester copolymer derived from
A1) vinyl esters of aliphatic, saturated carboxylic acids having a chain length of C₁-C₄;
A2) alpha-olefins having 2 to 8 carbon atoms; and/or
A3) vinyl esters of aliphatic, saturated carboxylic acids having a chain length of C₅-C₁₈;
A4) optionally, esters of ethylenically unsaturated monocarboxylic or dicarboxylic acids with monohydric saturated alcohols; and
A5) optionally, further comonomers,
wherein the sum of A1), A2), and/or A3), and/or A4), and/or A5) equal 100% by weight.

31. The process of claim 30, wherein A1) is vinyl acetate.

32. The process of claim 30, wherein said at least one vinyl ester copolymer is derived from A1), A2), and optionally A4), and wherein A2) is ethylene.

33. The process of claim 32, wherein said at least one vinyl ester copolymer is a vinyl acetate-ethylene copolymer.

34. The process of claim 30, wherein said at least one vinyl ester copolymer is derived from A1), A3), and optionally A4), and wherein A3) is a vinyl ester of α-branched carboxylic acid having 9 to 11 carbon atoms in the acid radical.

35. The process of claim 22, wherein said dispersion comprises up to 2% by weight, based on the total monomer amount, of a protective colloid composed of a water-soluble or water-dispersible polymer.

36. The process of claim 22, wherein said dispersion comprises nonionic emulsifiers selected from the group consisting of acyl oxethylates, alkyl oxethylates, oleyl oxethylates.

37. The process of claim 22, wherein said dispersion comprises anionic emulsifiers selected from the group consisting of sodium, potassium, and ammonium salts of linear aliphatic carboxylic acids of chain length C₁₂-C₂₀; sodium hydroxyoctadecanesulfonate;
sodium, potassium, and ammonium salts of hydroxy fatty acids of chain length C₁₂-C₂₀ and their sulfonation, sulfation, and acetylation products; alkyl sulfates; triethanolamine salts of alkyl sulfates; alkyl(C₁₀-C₂₀)sulfonates; alkyl(C₁₀-C₂₀)arylsulfonates; dimethyl-dialkyl (C₈-C₁₈)ammonium chloride and their sulfonation products; lignosulfonic acid and its calcium, magnesium, sodium, and ammonium salts; resin acids; hydrogenated and dehydrogenated resin acids and their alkali metal salts, dodecylated sodium diphenyl ether disulfonate; sodium lauryl sulfate; ethoxylated sodium lauryl ether sulfate; the salt of a bisester of a sulfonated dicarboxylic acid having 4 to 8 carbon atoms; and mixtures thereof.

38. The process of claim 22, wherein the jet from said nozzle has a diameter of less than 6 mm.

39. An aqueous, emulsifier-containing, polyvinyl ester polymer dispersion for nozzle application to a substrate, wherein said dispersion has a solids content of at least 40% by weight and a viscosity of less than 8000 mPas, and wherein said polymer has a glass transition temperature of −30 to 40° C.

40. The aqueous, emulsifier-containing, polyvinyl ester polymer dispersion of claim 39, wherein said nozzle application is dotwise or linear.

41. The aqueous, emulsifier-containing, polyvinyl ester polymer dispersion of claim 39, wherein the emulsifier of said dispersion comprises at least one nonionic emulsifier comprising alkylene oxide groups and/or at least one anionic emulsifier comprising sulfate, sulfonate, phosphate, and/or phosphonate groups.

42. The aqueous, emulsifier-containing, polyvinyl ester polymer dispersion of claim 39, wherein said substrate is bonding paper used in the production of folding boxes, UV-coated folding boxes, envelopes, brochures, and cigarettes.
